(19) United States
(12) Patent Application Publication
(10) Pub. No.: US 2007/0170072 A1
(43) Pub. Date: Jul. 26, 2007

(54) Electrolytic facility having pulses for killing germs and for removing fouling

(76) Inventor: Wen Shing Shyu, Taichung (TW)

Correspondence Address: CHARLES E. BAXLEY, ESQ., 90 JOHN STREET, THIRD FLOOR, NEW YORK, NY, 10038, US

(21) Appl. No.: 11/338,939

(22) Filed: Jan. 25, 2006

(51) Int. Cl. C02F 1/461

(52) U.S. Cl. 205/701

(57) ABSTRACT

An electrolytic facility includes an electrolyzing circuit coupled to an electrode chamber for conducting an electrolyzing operation, a pulse generating circuit coupled to the electrode chamber for generating pulses to kill germs and to remove fouling in the electrode chamber, and a switch device for selectively switching on the electrolyzing circuit or the pulse generating circuit. The pulses generated by the pulse generating circuit are preferably periodically generated in equal time interval, and preferably include a voltage contrary to the electrolyzing voltage for conducting the electrolyzing operation.

### BACKGROUND OF THE INVENTION

1. Field of the Invention

The present invention relates to an electrolytic facility, and more particularly to an electrolytic facility having pulses generated for killing germs and/or for removing fouling in an electrode chamber.

2. Description of the Prior Art

Typical electrolytic facilities may comprise an electrode chamber for receiving an electrolytic solution therein for electrolyzing purposes, and germs may be generated within the electrolytic solution or in the electrode chamber.

Conventionally, one or more ultra violet light tubes or micro filter devices have been provided or used for killing germs or for filtering the germs. However, the ultra violet light tubes or the micro filter devices may increase the manufacturing cost for the typical electrolytic facilities.

In addition, in typical electrolytic facilities, one or more cathode coppers or plates will be disposed in the electrode chamber and dipped within the electrolytic solution, and calcium materials, such as calcium carbonate CaCo₃, and/or carbon materials will be deposited on the cathode coppers or plates to form a calcium fouling problem.

For removing the deposited calcium and/or carbon, a lemon acid or acetic acid will be used for soaping and washing the cathode coppers or plates to remove the deposited calcium and/or carbon from the cathode coppers or plates. However, it is inconvenient and it is time consuming for soaping and washing the cathode coppers or plates with the lemon acid or the acetic acid.

The other methods may apply a voltage into the electrolytic solution that is received in the electrode chamber in order to remove the deposited calcium and/or carbon from the cathode coppers or plates. However, the alkali solution will be changed or converted into an acid solution by the voltage, and the acid solution will be changed or converted into an alkali solution by the voltage, such that the electrolytic solution should be suitably or frequently circulated.

The present invention has arisen to mitigate and/or obviate the afore-described disadvantages of the conventional methods for killing germs and for removing fouling in the typical electrode chambers of the electrolytic facilities.

### SUMMARY OF THE INVENTION

The primary objective of the present invention is to provide an electrolytic facility having a circuit for generating high voltage pulses and for killing germs and/or for removing fouling in an electrode chamber.

In accordance with one aspect of the invention, there is provided an electrolytic facility comprising an electrode chamber for receiving an electrolytic solution and at least one cathode plate, an electrolyzing circuit coupled to the electrode chamber for conducting an electrolyzing operation, a pulse generating circuit coupled to the electrode chamber for generating pulses to kill germs and to remove fouling in the electrode chamber, and a switch device coupled between the electrolyzing circuit and the pulse generating circuit for selectively switching on the electrolyzing circuit or the pulse generating circuit.

The pulses are preferably periodically generated in equal time interval. The pulses preferably include a voltage contrary to an electrolyzing voltage for conducting the electrolyzing operation.

The switch device includes at least one field effect transistor coupled to a central processing unit and coupled to the electrolyzing circuit and the pulse generating circuit for selectively switching on the electrolyzing circuit or the pulse generating circuit.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating an electric circuit for am electrolytic facility in accordance with the present invention;

FIG. 2 is a partial plan schematic view illustrating a portion of the electric circuit for conducting electrolyzing operation;

FIG. 3 is a partial plan schematic view illustrating another portion of the electric circuit for conducting high voltage pulse generating operation;

FIG. 4 is a plan schematic view illustrating the generated high voltage pulse for a positive electrolyzing operating voltage;

FIG. 5 is a plan schematic view illustrating the generated high voltage pulse for a negative electrolyzing operating voltage;

FIG. 6 is a block diagram illustrating the switching between the electrolyzing operation and the high voltage pulse generating operation;

FIG. 7 is a plan schematic view illustrating the electric circuit of that shown in FIG. 6 for switching between the electrolyzing operation and the high voltage pulse generating operation;

FIG. 8 is a plan schematic view illustrating the ion display of the electrolyzing operation; and

FIG. 9 is a plan schematic view illustrating the ion display of the high voltage pulse generating operation.

### DETAILED DESCRIPTION OF THE PREFERRED EMBODIMENT

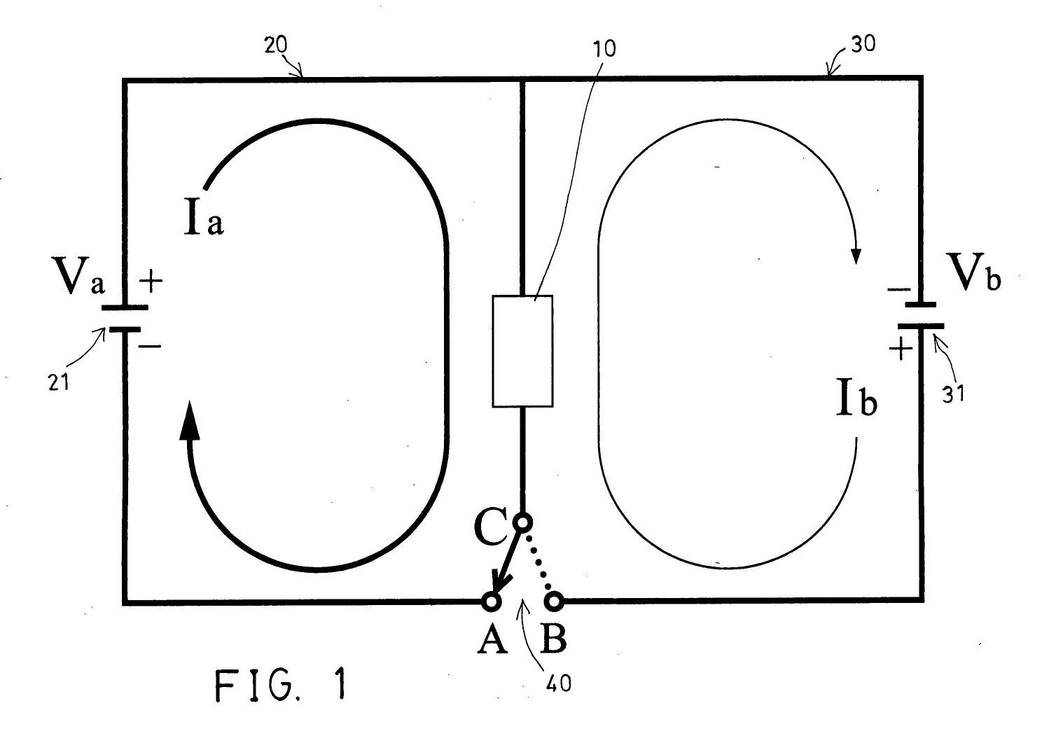

Referring to the drawings, and initially to FIG. 1, an electrolytic facility in accordance with the present invention is to provide pulses for killing germs and/or for removing fouling in an electrode chamber 10, and comprises an electric circuit 20 for conducting electrolyzing operation, and another electric circuit 30 for conducting high voltage pulse generating operation.

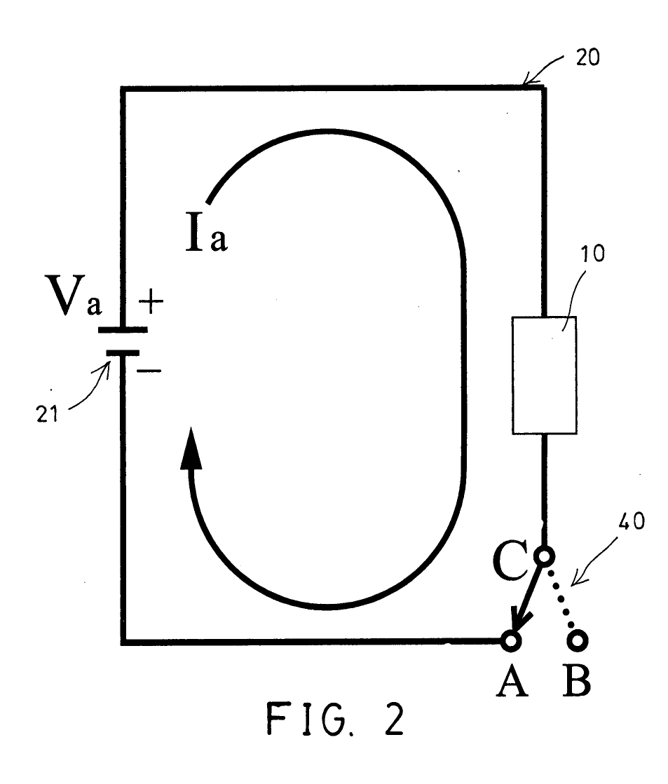

For example, as shown in FIGS. 1 and 2, the electrolyzing circuit 20 includes an electric power source 21 coupled to the electrode chamber 10 for generating or applying a typical or normal voltage Va and a typical or normal current Ia to the electrode chamber 10 and for conducting the typical electrolysis or electrolyzing operation.

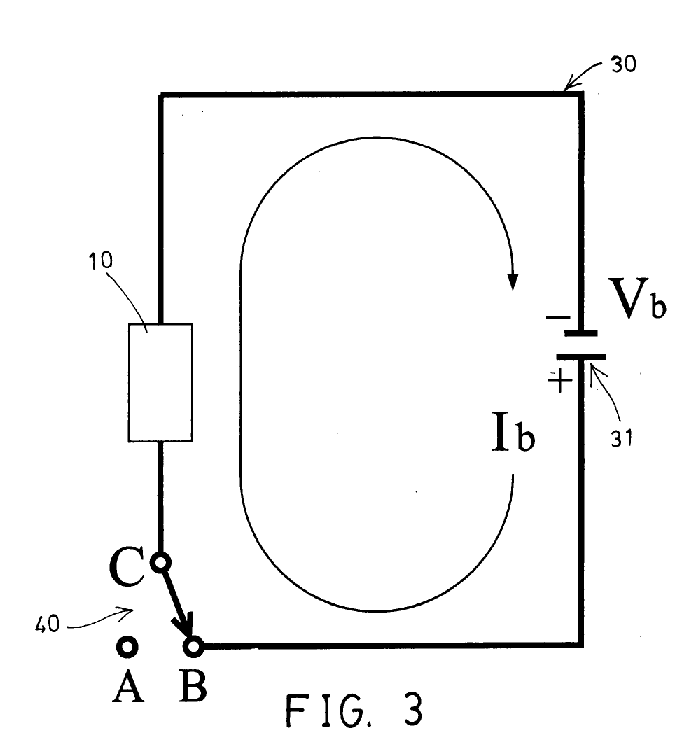

As shown in FIGS. 1 and 3, the high voltage pulse generating circuit 30 includes an electric power source 31 coupled to the electrode chamber 10 for applying a high voltage Vb and a current Ib to the electrode chamber 10 and for generating one or more high voltage pulses to kill germs and/or to remove the fouling in the electrode chamber 10, such as on the cathode coppers or plates that are provided and disposed in the electrode chamber 10.

As shown in FIG. 1, a switch device 40, such as an electronic instant switch device 40 is further provided and coupled to or between the electrolyzing circuit 20 and the high voltage pulse generating circuit 30 for selectively switching on the electrolyzing circuit 20 (FIG. 2) or the high voltage pulse generating circuit 30 (FIG. 3). When the electrolyzing circuit 20 is switched on, the high voltage pulse generating circuit 30 will be switched off, and when the high voltage pulse generating circuit 30 is switched on, the electrolyzing circuit 20 will be switched off.

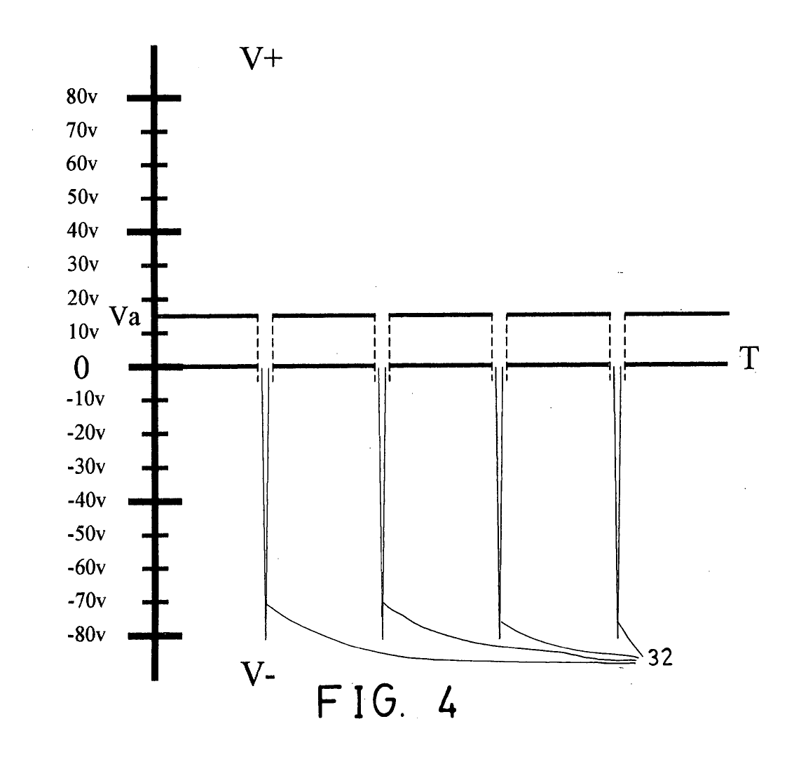

As shown in FIG. 4, when the voltage Va conducting the electrolysis or electrolyzing operation is positive, one or more high voltage pulses 32 of high negative voltage will be periodically generated in equal time interval to kill germs and/or to remove the fouling in the electrode chamber 10. It is preferable that the high voltage pulses 32 are periodically generated in a predetermined time interval, and the high negative voltage Vb is preferably two or more times greater than that of the electrolyzing operating voltage Va.

The rate of the high negative pulse generating voltage Vb, the spaced distances between the cathode coppers or plates, the germ containing rate of the electrolytic solution contained in the electrode chamber 10, the softness or the hardness of the electrolytic solution, and the other characters may be used to determine the times for generating the high voltage pulses 32.

For example, when the electrolytic solution or water flows out of the electrode chamber 10 in a rate of 2000 cc/min, and the volume of the electrode chamber 10 is 50 cc, the times for generating the high voltage pulses 32 may be calculated or determined by at least: 2000/50=40 times per minute. It is preferable that the pulse generating voltage Vb is negative which is contrary to the positive electrolysis or electrolyzing voltage Va.

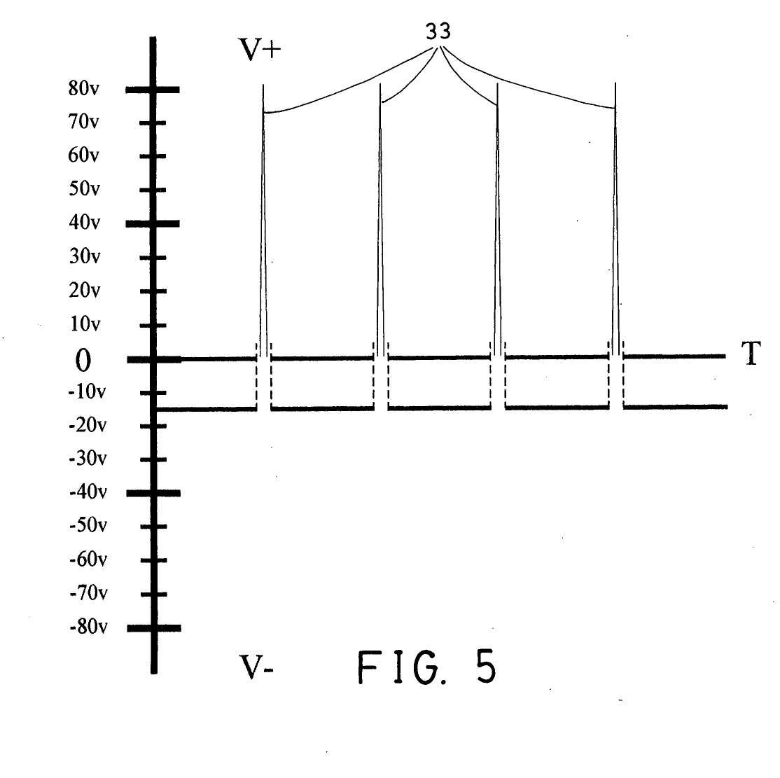

As shown in FIG. 5, when the voltage Va conducting the electrolysis or electrolyzing operation is negative, one or more high voltage pulses 33 of high positive voltage will be periodically generated to kill germs and/or to remove the fouling in the electrode chamber 10. It is preferable that the high positive voltage pulses 33 are periodically generated in a predetermined time interval, and the high positive voltage Vb is preferably two or more times of that of the electrolyzing operating voltage Va. The fouling and/or the deposited calcium materials removed from the cathode coppers or plates or in the electrode chamber 10 may flow out of the electrode chamber 10 together with the electrolytic solution.

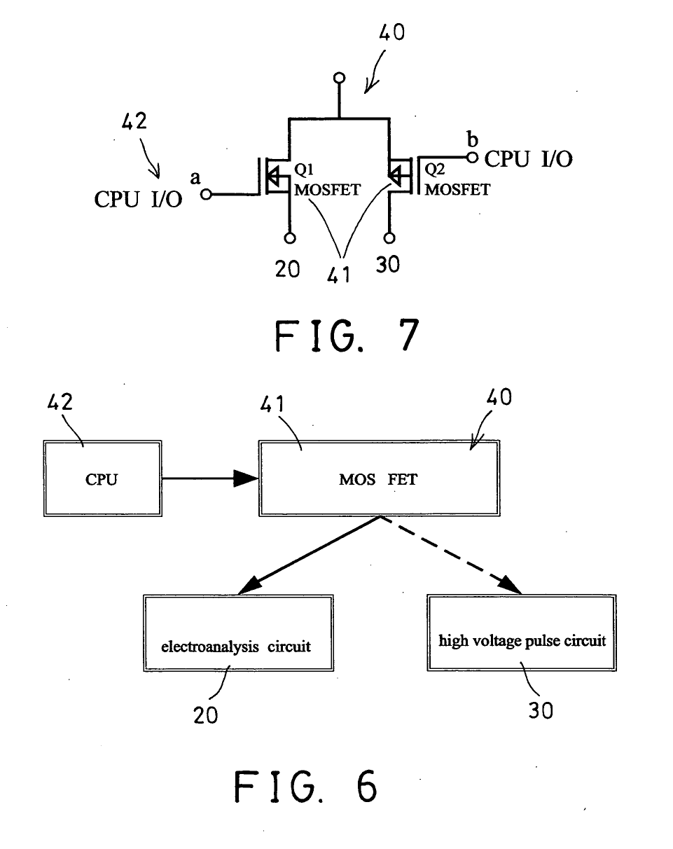

As shown in FIGS. 6 and 7, the electronic instant switch device 40 includes one or more field effect transistors (FET) 41 coupled to a central processing unit (CPU) 42 and coupled to the electrolyzing circuit 20 and the high voltage pulse generating circuit 30 for selectively and instantly or quickly switching on the electrolyzing circuit 20 or the high voltage pulse generating circuit 30.

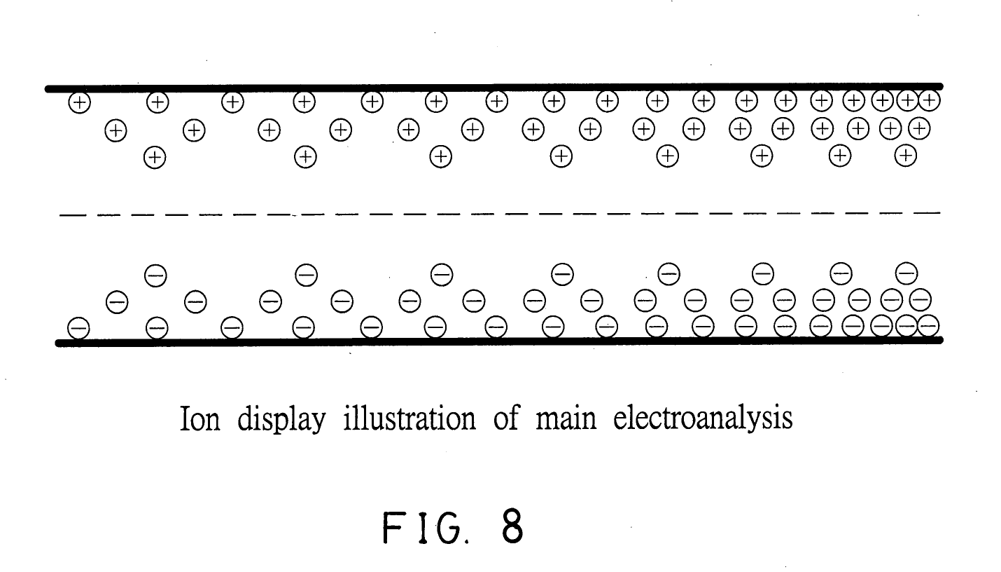

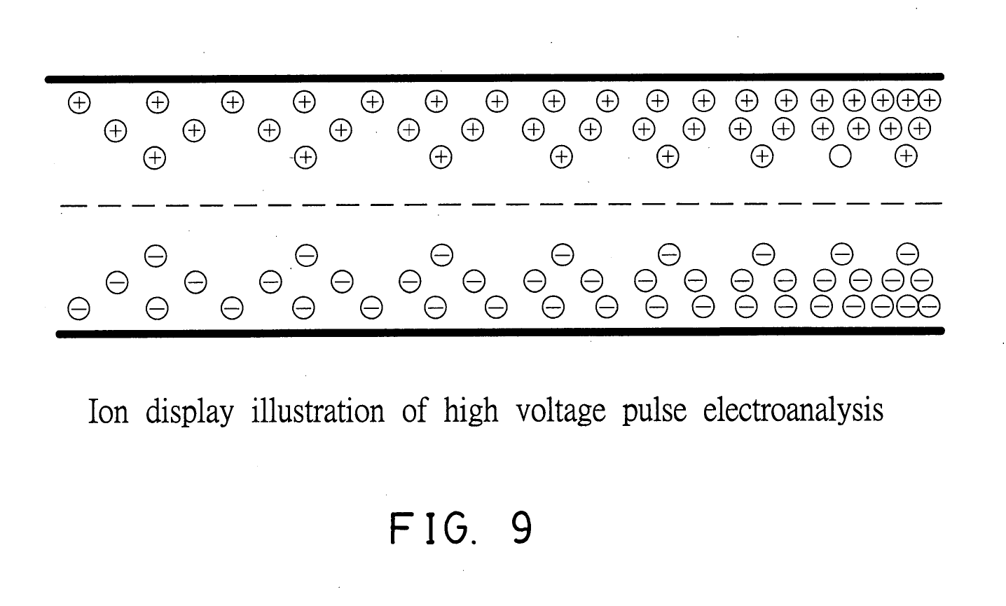

As shown in FIG. 8, illustrated is the ion display when the typical electrolysis or electrolyzing operation is conducted or operated, and as shown in FIG. 9, illustrated is the ion display when the high voltage pulse generating operation is conducted or operated. From the ion display for both the electrolyzing operation and the high voltage pulse generating operation, we can see that the ion display has not be greatly changed or changed or mixed or interfered with the positive ion, such that the electrolyzing operation will not be affected by the high voltage pulse generating operation.

It is to be noted that the pulse generating voltage Vb is two or more times greater than that of the electrolyzing operating voltage Va, but the high voltage pulses 32, 33 will be generated in few millisecond (10⁻³ sec), such that the pulse generating current Ib will be much smaller than the electrolyzing current Ia, and thus will not affect the electrolyzing operation.

Accordingly, the electrolytic facility in accordance with the present invention includes a circuit for generating high voltage pulses and for killing germs and/or for removing fouling in the electrode chamber.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrolytic facility comprising:
an electrode chamber for receiving an electrolytic solution and at least one cathode plate,
an electrolyzing circuit coupled to said electrode chamber for conducting an electrolyzing operation,
a pulse generating circuit coupled to said electrode chamber for generating pulses to kill germs and to remove fouling in said electrode chamber, and
a switch device coupled between said electrolyzing circuit and said pulse generating circuit for selectively switching on said electrolyzing circuit or said pulse generating circuit.

2. The electrolytic facility as claimed in claim 1, wherein said pulses are periodically generated in equal time interval.

3. The electrolytic facility as claimed in claim 1, wherein said pulses include a voltage contrary to an electrolyzing voltage for conducting the electrolyzing operation.

4. The electrolytic facility as claimed in claim 1, wherein said switch device includes at least one field effect transistor coupled to a central processing unit and coupled to said electrolyzing circuit and said pulse generating circuit for selectively switching on said electrolyzing circuit or said pulse generating circuit.
